(19) United States
(12) Patent Application Publication
(10) Pub. No.: US 2025/0073858 A1
(43) Pub. Date: Mar. 6, 2025

(54) WRENCH

(71) Applicant: Jun-Fan CHEN, Taichung City (TW)

(72) Inventor: Jun-Fan CHEN, Taichung City (TW)

(21) Appl. No.: 18/457,744

(22) Filed: Aug. 29, 2023

(51) Int. Cl. B25B 13/06

(52) U.S. Cl. CPC B25B 13/06

(57) ABSTRACT

A wrench includes a main body and a driving head. The main body includes a body portion and a head portion connected to the body portion, the head portion includes a jaw, the jaw includes two side walls and a bottom wall connected between the two side walls, and between each of the two side walls and the bottom wall is a concave portion which is recessed in one of the two side walls and the bottom wall. The drive head is rotatably connected to the head portion and within a slot of the head portion, and a rotation axis of the drive head extends toward the two side walls.

### BACKGROUND OF THE INVENTION

### Field of the Invention

The present invention relates to a wrench.

### Description of the Prior Art

A conventional wrench generally includes a handle and a working head swingably connected to the handle. The working head includes two arms spaced apart from each other to form a slot. The working head is rotatably connected between the two arms so that the working head can be rotated to be perpendicular to the handle for turning operation. However, as the working head receives a large torque or turning force, the roots of the two arms are easy to break, so it is not durable and has a short service life.

The present invention is, therefore, arisen to obviate or at least mitigate the above-mentioned disadvantages.

### SUMMARY OF THE INVENTION

The main object of the present invention is to provide a wrench which can improve the structural strength, avoid the wearing thereof, and increase the durability.

To achieve the above and other objects, a wrench is provided, wherein the wrench includes: a main body including a body portion and a head portion connected to the body portion, the head portion including a jaw, the jaw including two side walls and a bottom wall connected between the two side walls, between each of the two side walls and the bottom wall being a concave portion which is recessed in one of the two side walls and the bottom wall; and a driving head rotatably connected to the head portion and within a slot of the head portion, a rotation axis of the driving head extending toward the two side walls.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a side view of an exemplary embodiment of the present invention;

FIG. 4 is a cross-sectional view of an exemplary embodiment of the present invention;

FIG. 5 is another side view of an exemplary embodiment of the present invention; and

FIG. 6 is a drawing showing operation of an exemplary embodiment of the present invention.

### DETAILED DESCRIPTION OF THE PREFERRED EMBODIMENTS

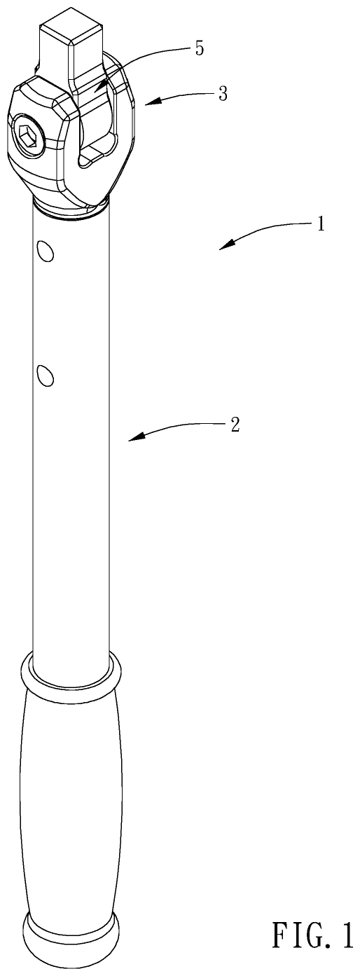

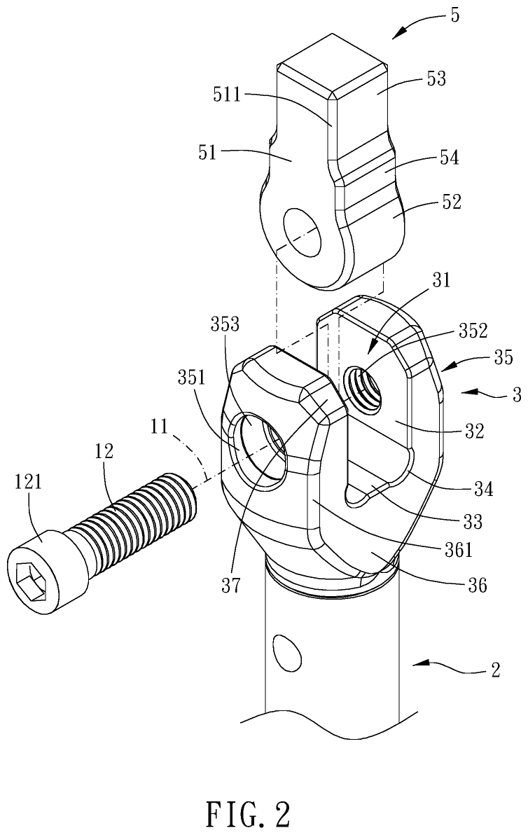

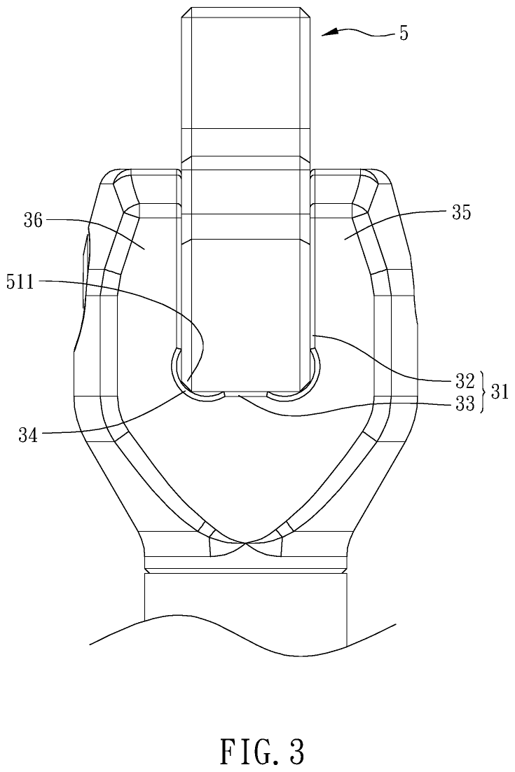

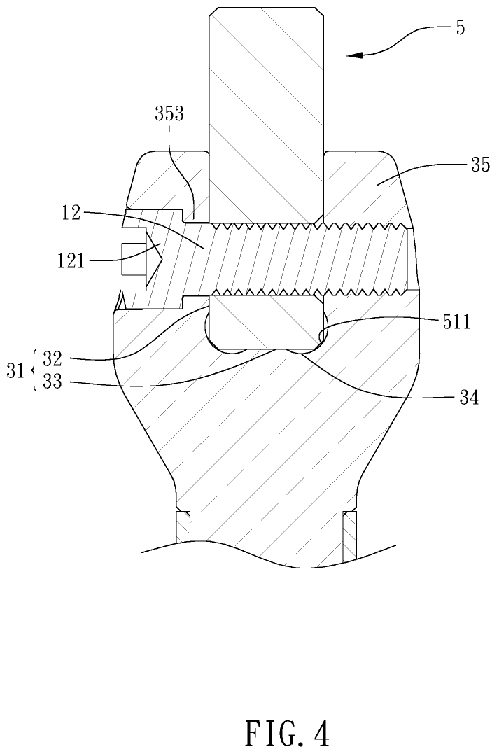

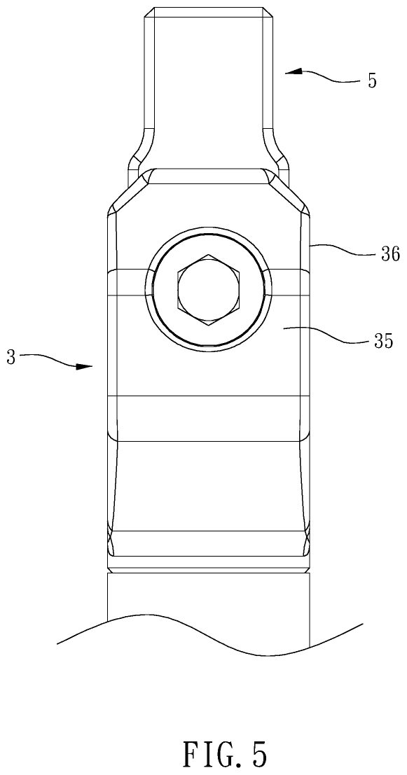

Please refer to FIGS. 1 to 6 for an exemplary embodiment of the present invention. A wrench of the present invention includes a main body 1 and a driving head 5. The main body 1 includes a body portion 2 and a head portion 3 connected to the body portion 2, the head portion 3 includes a jaw 31, the jaw 31 includes two side walls 32 and a bottom wall 33 connected between the two side walls 32, and between each of the two side walls 32 and the bottom wall 33 is a concave portion 34 which is recessed in one of the two side walls 32 and the bottom wall 33.

The driving head 5 is rotatably connected to the head portion 3 and within a slot of the head portion 3, a rotation axis 11 of the driving head 5 extending toward the two side walls 32, and the driving head 5 is configured to be connected with fastening member (such as bolt or socket).

Since the concave portions 34 are recessed in the two side walls 32 and the bottom wall 33, respectively, it can prevent stress concentration on the interconnected regions between the two side walls 32 and the bottom wall 33, and the concave portions 34 can avoid the wearing of the driving head 5 when swinging relative to the head portion 3, which can increase the durability and maintain the appearance.

Specifically, the head portion 3 further includes two arms 35, and each of the two arms 35 includes one of the two side walls 32 and is tapered in a direction away from the body portion 2. The tapered arms 35 are convenient for the head portion 3 to reach into the narrow working space.

In this embodiment, one of the two arms 35 further includes a through hole 351, the other of the two arms 35 further includes a threaded hole 352, and a shaft 12 is disposed through the through hole 351 and the driving head 5 and screwed to the threaded hole 352, so that the driving head 5 is rotatable about the shaft 12. Preferably, a blocking portion 353 is located in the through hole 351, and a large diameter section 121 of the shaft 12 is axially blocked by the blocking portion 353 to position the shaft 12.

Each of two sides of the head portion 3 transverse to the rotation axis 11 includes a first plane 36. The first planes 36 increase the swing angle of the driving head 5 to avoid interference. Between the first plane 36 and an end of the head portion 3 remote from the body portion 2 is a bevel 37, which is convenient for the head portion 3 to reach into the narrow working space. Preferably, a first chamfer 361 is disposed on a perimeter of each of the two first planes 36, which avoids collision by foreign objects and scratch the surface thereof.

Each of two sides of the driving head 5 transverse to the rotation axis 11 includes a second plane 51 corresponding to one of the two side walls 32. The two second planes 51 are aligned and contact with the two side walls 32, thus avoiding the driving head 5 from shaking relative to the head portion 3. Preferably, a second chamfer 511 is disposed on a perimeter of the second plane 51, so that it can avoid damage to objects and ensure that the driving head 5 will not be in contact with the two concave portions 34.

The driving head 5 includes a pivot portion 52 and a working portion 53, and as viewed in the rotation axis 11, the pivot portion 52 has a diametric dimension larger than a diametric dimension of the working portion 53, which increases the swinging range of the driving head 5. In this embodiment, the working portion 53 is quadrangular and configured to be assembled with a quadrangular connection hole of a socket.

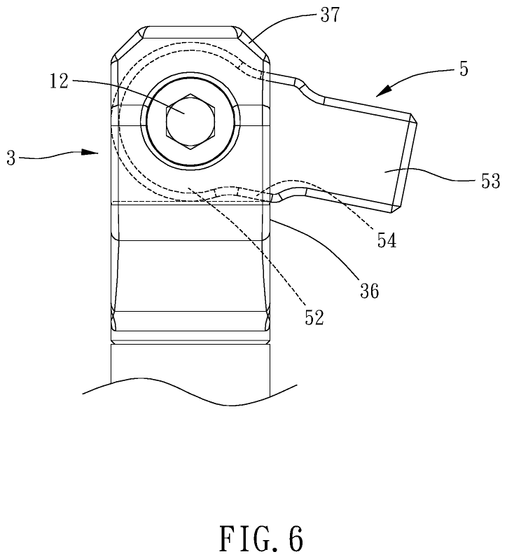

The driving head 5 further includes a connection section 54, as viewed in the rotation axis 11, the pivot portion 52 is major-arced, and the connection section 54 has a diametric dimension smaller than the diametric dimension of the pivot portion 52 and larger than the diametric dimension of the working portion 53. When the driving head 5 swings to be in such a manner that the connection 5 section 54 is abutted against the bottom wall 33, the driving head 5 is at a maximum angle relative to the head portion 3 (FIG. 6).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A wrench including:
a main body including a body portion and a head portion connected to the body portion, the head portion including a jaw, the jaw including two side walls and a bottom wall connected between the two side walls, between each of the two side walls and the bottom wall being a concave portion which is recessed in one of the two side walls and the bottom wall; and
a driving head rotatably connected to the head portion and within a slot of the head portion, a rotation axis of the driving head extending toward the two side walls.

2. The wrench of claim 1, wherein the head portion further includes two arms, and each of the two arms includes one of the two side walls and is tapered in a direction away from the body portion.

3. The wrench of claim 2, wherein one of the two arms further includes a through hole, the other of the two arms further includes a threaded hole, and a shaft is disposed through the through hole and the driving head and screwed to the threaded hole.

4. The wrench of claim 1, wherein each of two sides of the head portion transverse to the rotation axis includes a first plane.

5. The wrench of claim 4, wherein between the first plane and an end of the head portion remote from the body portion is a bevel.

6. The wrench of claim 4, wherein a first chamfer is disposed on a perimeter of the first plane.

7. The wrench of claim 1, wherein each of two sides of the driving head transverse to the rotation axis includes a second plane corresponding to one of the two side walls.

8. The wrench of claim 7, wherein a second chamfer is disposed on a perimeter of the second plane.

9. The wrench of claim 1, wherein the driving head includes a pivot portion and a working portion, and as viewed in the rotation axis, the pivot portion has a diametric dimension larger than a diametric dimension of the working portion.

10. The wrench of claim 3, wherein each of two sides of the head portion transverse to the rotation axis includes a first plane; between the first plane and an end of the head portion remote from the body portion is a bevel; a first chamfer is disposed on a perimeter of the first plane; each of two sides of the driving head transverse to the rotation axis includes a second plane corresponding to one of the two side walls; a second chamfer is disposed on a perimeter of the second plane; the driving head includes a pivot portion and a working portion, and as viewed in the rotation axis, the pivot portion has a diametric dimension larger than a diametric dimension of the working portion; the driving head further includes a connection section, as viewed in the rotation axis, the pivot portion is major-arced, and the connection section has a diametric dimension smaller than the diametric dimension of the pivot portion and larger than the diametric dimension of the working portion; the working portion is quadrangular; a blocking portion is located in the through hole, and a large diameter section of the shaft is axially blocked by the blocking portion.
